(19) United States
(12) Patent Application Publication
(10) Pub. No.: US 2025/0206544 A1
(43) Pub. Date: Jun. 26, 2025

(54) DAMPING ELEMENT

(71) Applicant: KRONES AG, Neutraubling (DE)

(72) Inventors: Thomas HARTWICH, Steinberg am See (DE); Janis LANGE, Dortmund (DE); Erik MERL, Regenstauf (DE)

(21) Appl. No.: 18/983,675

(22) Filed: Dec. 17, 2024

(30) Foreign Application Priority Data
Dec. 21, 2023 (DE) 20 2023 107 577.0

(51) Int. Cl. B65G 47/84; B33Y 80/00

(52) U.S. Cl. CPC B65G 47/846; B33Y 80/00; B65G 2201/0244; B65G 2207/42; B65H 2401/111

(57) ABSTRACT

The invention relates, inter alia, to a damping element for a container receiving pocket of a container transport starwheel. The damping element has an elastically deformable damping section which has a contact face for contacting a container. The damping element has a preferably elastically deformable mounting section for mounting the damping element in the container receiving pocket of the container transport starwheel. The damping section and the mounting section are formed from a plurality of adjacent, preferably additively manufactured, material layers.

### CROSS REFERENCE TO RELATED APPLICATIONS

This application claims the benefit under 35 U.S.C. § 119 (a) of German Patent Application No. DE 20 2023 107 577.0, filed Dec. 21, 2023, entitled DAMPING ELEMENT, and whose entire disclosure is incorporated by reference herein.

### TECHNICAL FIELD

The invention relates to a damping element for a container receiving pocket of a container transport starwheel. The invention further relates to a transport starwheel for transporting containers. The invention further relates to a method and a computer program product.

### TECHNICAL BACKGROUND

Conveyor systems in container treatment systems for filling and closing containers, such as bottles, can comprise transport starwheels. Transport starwheels are known, for example, from EP 2 447 194 A1 and EP 4 197 945 A1.

A transport starwheel is a rotary conveyor that can transport containers in rotation about a central vertical axis of the transport starwheel. For example, a transport starwheel can be arranged as an infeed starwheel or an outlet starwheel of a rotary container treatment device, such as a filler carousel or a capper carousel. A transport starwheel can have container receiving pockets in which the containers are held during transport. When a container is transferred into a container receiving pocket, the container may accelerate and change direction. In order to keep wear and tear on the container and the container receiving pocket as low as possible, transfer and transport should be as gentle as possible.

The invention is based on the object of creating an improved technology for the gentle transfer and transport of containers by means of a transport starwheel, wherein the technology can preferably be used with a wide variety of container formats and can be easily adapted to them.

### SUMMARY OF THE INVENTION

The object is achieved by the features of the independent claims. Advantageous developments are specified in the dependent claims and the description.

One aspect of the present disclosure relates to a damping element for a container receiving pocket of a container transport starwheel. The damping element has an elastically deformable damping section which has a contact face for contacting a container, and a-preferably elastically deformable-mounting section for mounting the damping element in the container receiving pocket of the container transport starwheel. Preferably, the damping section and the mounting section can (each) be formed from a plurality of adjacent, preferably additively manufactured, material layers.

Advantageously, the damping element can make it possible to slow down a container as it enters the container receiving pocket. The container can strike the contact face, and then the container can be braked by means of elastic deformation of the damping section. Overall, this advantageously makes possible a particularly gentle transfer and transport of the container, which can prevent damage to the container. The production of the damping element in a plurality of adjacent material layers by means of additive manufacturing is particularly advantageous. There is no need to design, produce and possibly store perhaps for decades a separate tool for every possible shape of the damping element adapted to a particular container format, e.g. for foaming, casting or injection-molding the damping element. Instead, additive manufacturing makes possible a flexible, needs-based and rapid (re) design and production of the damping element from an elastically deformable material.

In one embodiment, the material layers are made of an elastically deformable (e.g. 3D-printable) plastic, preferably a thermoplastic polyurethane (TPU), particularly preferably a TPU with a Shore A hardness of between approx. 70 and approx. 95. This means that an elastically deformable (flexible) and resistant material can be used advantageously in the production of the damping element.

In a further embodiment, the damping element as a whole has a Shore A hardness of between approx. 30 and approx. 90, preferably between approx. 30 and approx. 80, particularly preferably between approx. 30 and approx. 50, due to its design (e.g. wall thickness, shape, structure) and material (e.g. material of the damping section and of the mounting section).

In a further embodiment, the contact face is roughened and/or the contact face has a predetermined profiling, texturing or patterning in order to increase friction between the container and the contact face. Advantageously, the container can thus be braked as it slides along the contact face during the reception of the container in the container receiving pocket.

In one embodiment, the damping section and the mounting section merge directly into one another. Alternatively or additionally, the damping section and the mounting section are integrally joined to one another. Alternatively or additionally, the damping element is a one-piece design. This is advantageous because it allows a particularly simple and reliable design of the damping element.

In a further embodiment, a common outer contour formed by the damping section and the mounting section substantially corresponds to a hat outer contour, preferably a bowler hat outer contour. Optionally, the damping section can form a hat crown of the hat outer contour. Alternatively or additionally, the mounting section can form a hat brim of the hat outer contour. This can advantageously make possible good handlability on the one hand and a good damping effect of the damping element on the other.

In one design variant, the damping section has a trough shape or shell shape. Alternatively or additionally, the damping section can have a preferably central recess, preferably a depression. Advantageously, the recess together with the elastic deformability of the damping section can make it possible for the damping section to be elastically compressible for damping the contact of the container.

In a further embodiment, the damping section has a (for example, elastically deformable) contact lip on which the contact face is arranged. Advantageously, the contact lip can provide particularly effective damping when the container strikes the contact face.

In one exemplary embodiment, the contact lip is curved, preferably C-shaped. Alternatively or additionally, the contact face can be arranged in an apical region of the contact lip. Alternatively or additionally, the contact lip can laterally delimit (bound) a recess, preferably a depression, of the damping section. Alternatively or additionally, a material thickness of the contact lip may increase toward a free end of the contact lip, preferably continuously and/or uniformly. Alternatively or additionally, the contact lip may have an essentially wedge-shaped cross-section in a plane perpendicular to a longitudinal extension of the contact lip. Advantageously, one design of the contact lip can thus make a particularly effective damping possible when the container strikes it.

In a further exemplary embodiment, the damping section further comprises a (for example, elastically deformable) side wall which is joined to the contact lip, preferably at a longitudinal edge of the contact lip and/or along an entire longitudinal course of the contact lip. This advantageously makes it possible for the contact lip to be supported in the unloaded state and in the unloaded state, thus making possible a lower material thickness of the contact lip. The side wall can advantageously make the design more stable overall and less susceptible to wear.

In one embodiment, the side wall delimits (bounds) a recess, preferably a depression, of the damping section on the bottom side. Alternatively or additionally, the contact lip may be positioned vertically on the side wall.

In a further embodiment, the side wall has a material thickness between 0.4 mm and 1.5 mm, preferably between 0.6 mm and 1 mm, preferably about 0.8 mm. Advantageously, a damping effect of the damping section which is particularly suitable for damping the impact of the containers can be realized.

In a further embodiment, a material thickness of the contact lip increases starting from the side wall in a direction away from the side wall and/or toward a free end of the contact lip, preferably continuously and/or uniformly, preferably from approx. 1 mm at the side wall to approx. 2 mm at the free end. Advantageously, this makes it possible to achieve a damping effect of the damping section that is particularly suitable for damping the impact of the containers, in particular taking into account the damping effect realized by the side wall of the damping section. This is particularly advantageous as it allows a uniform damping effect to be achieved across the entire contact face.

In one design variant, the mounting section is elongated and/or plate-shaped. Alternatively or additionally, the damping section may extend out from a central region of the mounting section. Alternatively or additionally, the mounting section may laterally delimit (bound) a recess, preferably a depression, of the damping section. Alternatively or additionally, opposite ends of the mounting section may project beyond the damping section and/or each have a recess, preferably a depression. Advantageously, one design of the mounting section can thus make possible a particularly simple and safe mounting of the damping element on the container receiving pocket of the container transport starwheel.

A further aspect of the present disclosure relates to a transport starwheel for transporting containers (e.g. for a container treatment system). The transport starwheel has a plurality of damping elements as disclosed herein. The transport starwheel further comprises at least one starwheel plate which has a plurality of, preferably arcuate, container receiving pockets distributed around its circumference. At least one, preferably two, of the plurality of damping elements for damping the reception of a container in the relevant container receiving pocket are arranged in each container receiving pocket. Advantageously, the transport starwheel can achieve the same advantages as already explained with reference to the damping element.

A further aspect of the present disclosure relates to a container treatment system (for example, for producing, cleaning, coating, inspecting, filling, closing, labeling, printing, and/or packaging containers for liquid media, preferably beverages or liquid foodstuffs). The container treatment system comprises at least one transport starwheel as disclosed herein.

A further aspect of the present disclosure relates to a use of a damping element as disclosed herein for damping an impact or a reception of a container in a container receiving pocket (e.g. a starwheel plate) of a container transport starwheel (e.g. in a container treatment system, e.g. as disclosed herein).

For example, the containers can be realized as bottles, cans, canisters, cartons, vials, tubes, etc.

A further aspect of the present disclosure relates to a method for producing a damping element as disclosed herein. The method comprises additively manufacturing the damping element (with the damping section and the mounting section), preferably in an additive powder bed manufacturing process.

A further aspect of the present disclosure relates to a computer program product comprising (e.g. at least one computer-readable storage medium having stored thereon) instructions that cause an additive manufacturing apparatus (for example, 3D printer) to produce a damping element as disclosed herein (with damping section and mounting section) in a plurality of material layers in an additive manufacturing process, preferably in an additive powder bed manufacturing process. Advantageously, a damping element having the advantages disclosed herein can thus be produced in a simple manner by means of an additive manufacturing device.

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 is a perspective view of a region of a container transport starwheel according to an exemplary embodiment of the present disclosure;

FIG. 2 is a perspective view of a damping element according to an exemplary embodiment of the present disclosure;

FIG. 3 is a bottom view of the exemplary damping element of FIG. 2; and

FIG. 4 is a sectional view of the exemplary damping element along a line A-A in FIG. 3.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

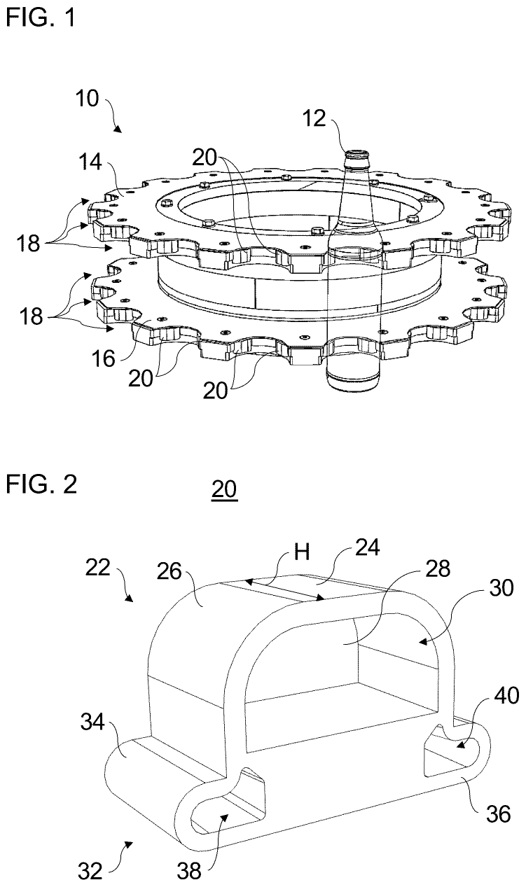

FIG. 1 shows a rotor or rotatable region of a transport starwheel 10 for transporting containers 12. Purely by way of example, only one container 12 is shown in FIG. 1. The transport starwheel 10 can also be referred to as a transfer starwheel, rotary container conveyor or container conveyor carousel.

Preferably, the transport starwheel 10 can be arranged in any section of a container treatment system for transporting containers 12. For example, the transport starwheel 10 can be arranged as an outlet starwheel or an infeed starwheel of a rotary container treatment device. Alternatively, the transport starwheel 10 can be arranged, for example, as part of a container conveyor system with a plurality of further container conveyors, e.g. further transport starwheels 10.

The transport starwheel 10 can take containers 12 from a container conveyor, rotate the obtained containers 12 about a central vertical axis of the transport starwheel 10 and then transfer them to a further container conveyor (not shown in FIG. 1).

The transport starwheel 10 has at least one starwheel plate 14, 16. Preferably, it comprises two starwheel plates 14, 16. The two starwheel plates 14, 16 can be arranged one above the other, preferably in alignment with one another. The at least one starwheel plate 14, 16 can be around a central vertical axis of the transport starwheel 10 for transporting the containers 12.

The at least one starwheel plate 14, 16 can have a plurality of container receiving pockets 18. The container receiving pockets 18 can be arranged, preferably uniformly distributed, around an outer circumference of the at least one starwheel plate 14, 16. Each container receiving pocket 18 can accommodate one container 12. A shape of the container receiving pockets 18 can be adapted to a shape of the containers 12. For example, the container receiving pockets 18 can be designed in the shape of a cylinder barrel segment.

At least one damping element 20 is arranged in each of the container receiving pockets 18. The at least one damping element 20 per container receiving pocket 18 can damp the reception of a container 12 in the relevant container receiving pocket 18. In detail, the at least one damping element 20 can gently brake the container 12 when it is received in the relevant container receiving pocket 18. The damping element 20 can therefore also be referred to as a braking element or a brake shoe.

For example, two damping elements 20 can be arranged per container receiving pocket 18, as shown in FIG. 1. The two damping elements 20 can be arranged at a distance from one another. Preferably, the two damping elements 20 can be located opposite one another.

FIGS. 2 to 4 show different views of a preferred damping element 20.

The damping element 20 comprises a damping section 22 and a mounting section 32.

The damping element 20 is additively manufactured. That is to say, the damping element 20 is manufactured in a plurality of material layers in an additive manufacturing process by an additive manufacturing device (e.g. 3D printer). Preferably, the damping element 20 can be manufactured in an additive powder bed manufacturing process.

In detail, the damping section 22 and the mounting section 32 are formed from a plurality of adjacent material layers. The material layers are manufactured additively. Preferably, the material layers may be made of an elastically deformable plastic, preferably a thermoplastic polyurethane (TPU), particularly preferably TPU 95.

The damping element 20 is preferably a one-piece design. Preferably, the damping section 22 and the mounting section 32 can merge directly into one another and/or be integrally joined to one another.

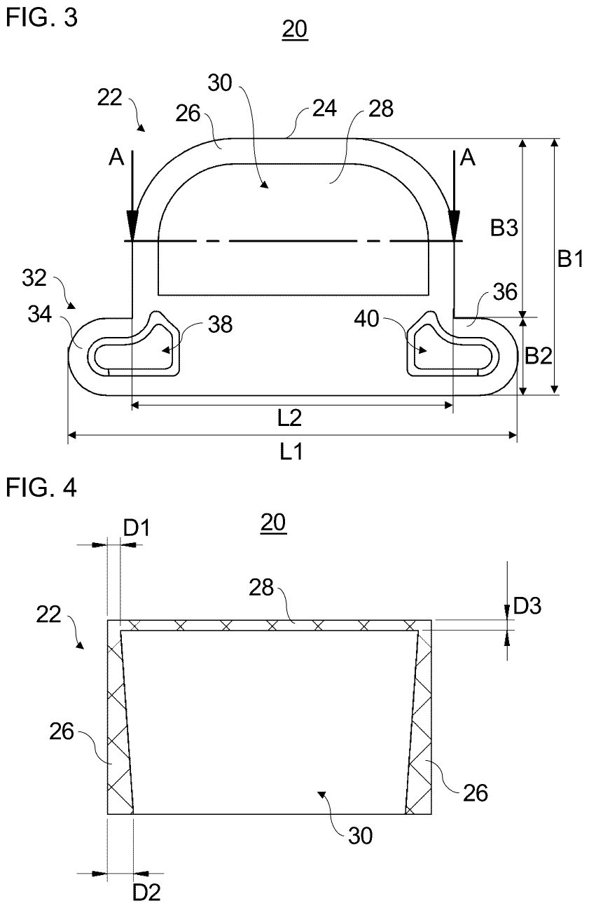

As shown by way of example in FIGS. 2 and 3, a common outer contour of the damping section 22 and the mounting section 32 can substantially correspond to a hat outer contour. The hat outer contour is preferably a bowler hat outer contour. Optionally, the damping section 22 can form a hat crown of the hat outer contour. The mounting section 32 can form a hat brim of the hat outer contour.

The damping section 22 comprises a contact face 24. Preferably, the damping section 22 can have a contact lip 26, a side wall 28 and/or a (damping section) recess 30.

The contact face 24 serves to contact the container 12 when damping the reception of the container 12 in the container receiving pocket 18 (see FIG. 1). Preferably, the contact face 24 can extend flat in one plane.

In the mounted state, the contact face 24 can face the container 12 or an interior of the container receiving pocket 18. In the mounted state, the contact face 24 can be aligned vertically.

The contact face 24 can be arranged on the contact lip 26. Preferably, the contact face 24 can be arranged on an apical region of the contact lip 26.

Preferably, the contact face 24 can be roughened. For example, the contact face 24 may have a predetermined profiling, texturing and/or patterning. Preferably, this can increase the friction between the container 12 and the contact face 24. The roughening (profiling, texturing and/or patterning) can preferably be produced directly during the additive manufacturing of the damping section 22. Preferably, the roughening can be formed as breaks in the adjacent material layers.

The contact lip 26 is preferably curved, particularly preferably C-shaped. The contact lip 26 can, for example, extend in an arcuate shape between spaced-apart ends/end regions 34, 36 of the mounting section 32.

The contact lip 26 can be joined directly to the side wall 28. Preferably, the side wall 28 can be joined to the contact lip 26 at a preferably arcuate longitudinal edge of the contact lip 26 and/or along an entire longitudinal course of the contact lip 26. The contact lip 26 can, for example, be positioned vertically on the side wall 28.

As shown in FIG. 4, the contact lip 26 can have a wedge-shaped cross-section. The cross-section can lie in a plane perpendicular to a longitudinal profile of the contact lip 26. Preferably, the cross-sections of the contact lip 26 can be wedge-shaped along the entire (e.g., arcuate) longitudinal course of the contact lip 26.

As is also shown in FIG. 4, the contact lip 26 can have a material thickness D1 at a transition to the side wall 28 that is less than a material thickness D2 at a free end or at an end of the contact lip 26 opposite the side wall 28. Preferably, a material thickness of the contact lip 26 can increase from the material thickness D1 at the side wall 28 to the material thickness D2 at the free end, preferably continuously and/or with a uniform gradient. For example, the material thickness D1 can be about 1 mm and the material thickness D2 can be about 2 mm.

The side wall 28 can be a flat side wall. In the mounted state, the side wall 28 can preferably lie in a horizontal plane. In the mounted state, the side wall 28 can preferably be an upper side of the damping element 20.

For example, the side wall 28 may have a substantially rectangular shape with two rounded corners on the same side of the side wall 28. The rounded corners can follow a course of the arcuate contact lip 26. On the side of the side wall 28 opposite the rounded corners, the side wall 28 can merge into the mounting section 32.

As shown in FIG. 4, the sidewall 28 can have a material thickness D3. The material thickness D3 can be less than the material thickness D1 and/or D2. For example, the material thickness D3 can be between 0.4 mm and 1.5 mm, preferably between 0.6 mm and 1 mm, preferably about 0.8 mm.

Overall, the damping section 22 can have a trough shape or a shell shape. This shape can be formed by the recess 30. The recess 30 can preferably be arranged centrally in the damping section 22. Preferably, the recess 30 can be formed as a depression.

The recess 30 can be laterally delimited by an inner side of the contact lip 26 and/or by an inner side of the mounting section 32. The recess 30 can be delimitied on the bottom side by the side wall 28.

The damping section 22 is elastically deformable. Preferably, the container 12 can contact the damping section 22 at the contact face 24. The damping section 22 can then deform elastically inwards in order to damp or slow down the container 12. The contact face 24 and the contact lip 26 as well as optionally the side wall 28 can be elastically deformed/pressed inwards or into the recess 30.

The mounting section 32 serves to mount the damping element 20 in or on the relevant container receiving pocket 18 of the transport starwheel 10.

The mounting section 32 may be elongated and/or plate-shaped. The damping section 22 can extend outwardly from a central region of the mounting section 32.

Opposite ends 34, 36 of the mounting section 32 can project beyond the damping section 22, e.g. with respect to a longitudinal axis of the mounting section 32. The ends 34, 36 can be arranged or designed as lug or wing sections of the damping element 22. The ends 34, 36 are preferably rounded.

Preferably, the ends 34, 36 of the mounting section 32 can each have a (mounting section) recess 38, 40. The recesses 38, 40 are preferably formed as depressions.

Preferably, the mounting section 32 can be elastically deformable. Preferably, this can facilitate mounting of the damping element 20 in/on the container receiving pocket 18. The ends 34, 36 can be pressed together during assembly due to the recesses 38, 40 in order to arrange the mounting section 32 in a correspondingly shaped receptacle in the container receiving pocket 18 and then secure it there, for example, in a positive-fitting and/or friction-fitting manner.

As shown in FIG. 3, the damping element 20 and/or the mounting section 32 can, for example, have a total length L1 between 20 mm and 50 mm, preferably between 30 mm and 40 mm, preferably about 35 mm. The damping section 22 can, for example, have a total length L2 between 15 mm and 35 mm, preferably between 20 mm and 30 mm, preferably about 25 mm.

As also shown in FIG. 3, the damping element 20 can, for example, have a total width B1 between 10 mm and 30 mm, preferably between 15 mm and 25 mm, preferably about 20 mm. The mounting section 32 can, for example, have a total width B2 between 4 mm and 8 mm, preferably between 5 mm and 7 mm. The damping section 22 can have a total width B3 between 8 mm and 18 mm, preferably between 10 mm and 16 mm.

As shown in FIG. 2, the damping element 20 and/or the damping section 22 and/or the mounting section 32 can have a total height H between 10 mm and 20 mm, preferably between 12 mm and 18 mm, preferably about 15 mm.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all features of independent claim 1 and, for example, independently of the features relating to the presence and/or the configuration of the damping section and/or of the mounting section of independent claim 1. All ranges specified herein are to be understood as disclosed in such a way that all values falling within the respective range are individually disclosed, e.g., also as the respective preferred narrower outer limits of the respective range.

### LIST OF REFERENCE SIGNS

10 transport starwheel
12 container
14 starwheel plate
16 starwheel plate
18 container receiving pocket
20 damping element
22 damping section
24 contact face
26 contact lip
28 side wall
30 recess
32 mounting section
34 first end
36 second end
38 first recess
40 second recess
D1-D3 material thickness
B1 damping element total width
B2 mounting section total width
B3 damping section total width
L1 damping element total length/mounting section total length
L2 damping section total length
H total height

What is claimed is:

1. A damping element for a container receiving pocket of a container transport starwheel, wherein the damping element comprises:
an elastically deformable damping section having a contact face for contacting a container; and
a mounting section for mounting the damping element in the container receiving pocket of the container transport starwheel,
wherein the damping section and the mounting section are formed from a plurality of adjacent material layers.

2. The damping element according to claim 1, wherein at least one of:
the material layers are made of an elastically deformable plastic; and
the damping element has as a whole due to its design and material a Shore A hardness of between 30 and 90.

3. The damping element according to claim 1, wherein at least one of:
the contact face is roughened; and
the contact face has a predetermined profiling, texturing or patterning to increase friction between the container and the contact face.

4. The damping element according to claim 1, wherein at least one of the following conditions is met:
the damping section and the mounting section merge directly into one another;
the damping section and the mounting section are integrally joined to one another; and
the damping element is a one-piece design.

5. The damping element according to claim 1, wherein:
a common outer contour formed by the damping section and the mounting section substantially corresponds to a hat outer contour.

6. The damping element according to claim 5, wherein at least one of:
the common outer contour substantially corresponds to a bowler hat outer contour;
the damping section forms a hat crown of the hat outer contour; and
the mounting section forms a hat brim of the hat outer contour.

7. The damping element according to claim 1, wherein at least one of:
the damping section has a trough shape or shell shape; and
the damping section has a recess.

8. The damping element according to claim 1, wherein at least one of:
the mounting section is elastically deformable;
the plurality of adjacent material layers are additively manufactured;
the material layers are made of thermoplastic polyurethane (TPU);
the material layers are made of TPU with a Shore A hardness of between 70 and 95;
the damping element has the Shore A hardness of between 30 and 80;
the damping element has the Shore A hardness of between 30 and 50;
the damping section has a central recess; and
the damping section has a depression.

9. The damping element according to claim 1, wherein:
the damping section has a contact lip on which the contact face is arranged.

10. The damping element according to claim 9, wherein at least one of the following conditions is met:
the contact lip is curved;
the contact face is arranged in an apical region of the contact lip;
the contact lip laterally delimits a recess of the damping section;
a material thickness of the contact lip increases toward a free end of the contact lip, and
the contact lip has an essentially wedge-shaped cross-section in a plane perpendicular to a longitudinal course of the contact lip.

11. The damping element according to claim 10, wherein at least one of the following conditions is met:
the contact lip is C-shaped;
the contact lip laterally delimits a depression of the damping section; and
the material thickness of the contact lip increases toward the free end of the contact lip at least one of continuously and uniformly.

12. The damping element according to claim 9, wherein:
the damping section further comprises a side wall which is connected to the contact lip.

13. The damping element according to claim 12, wherein at least one of:
the side wall delimits a recess of the damping section on the bottom side; and
the contact lip is perpendicular to the side wall.

14. The damping element according to claim 12, wherein:
the side wall has a material thickness between 0.4 mm and 1.5 mm.

15. The damping element according to claim 12, wherein:
a material thickness of the contact lip increases starting from the side wall in a direction at least one of away from the side wall and toward a free end of the contact lip.

16. The damping element according to claim 12, wherein at least one of:
the side wall is connected to the contact lip at least one of at a longitudinal edge of the contact lip and along an entire longitudinal course of the contact lip;
the side wall delimits a depression of the damping section on the bottom side;
the side wall has a material thickness between 0.6 mm and 1 mm;
the side wall has the material thickness of about 0.8 mm;
a material thickness of the contact lip increases starting from the side wall in a direction at least one of away from the side wall and toward a free end of the contact lip at least one of continuously and uniformly; and
the material thickness of the contact lip increases starting from the side wall in the direction at least one of away from the side wall and toward the free end of the contact lip from approximately 1 mm at the side wall to approximately 2 mm at the free end.

17. The damping element according to claim 1, wherein at least one of the following conditions is met:
the mounting section is at least one of elongated and plate-shaped;
the damping section extends outwardly from a central region of the mounting section;
the mounting section laterally delimits a recess of the damping section; and
at least one of opposite ends of the mounting section project beyond the damping section and each opposite end of the mounting section has a recess.

18. A transport starwheel for transporting containers, wherein the transport starwheel comprises:
a plurality of damping elements according to claim 1; and
at least one starwheel plate which has a plurality of container receiving pockets distributed around its circumference, wherein in each of the container receiving pockets at least one of the plurality of damping elements for damping a reception of a container is arranged in the relevant container receiving pocket.

19. A method for producing a damping element according to claim 1, wherein the method comprises
additively manufacturing the damping element with the damping section and the mounting section.

20. A computer program product having instructions causing an additive manufacturing apparatus to:
produce a damping element according to claim 1 in a plurality of material layers in an additive manufacturing process.
